(19) United States
(12) Patent Application Publication
(10) Pub. No.: US 2004/0192149 A1
(43) Pub. Date: Sep. 30, 2004

(54) Method and apparatus for aiding alignment and attachment of deflection yoke onto cathode ray tube funnel

(75) Inventors: Dean Vincent Pieretti, Greensburg, PA (US); Jamie Brian Kriebel, Greensburg, PA (US); Charles F. Fair, Greensburg, PA (US)

Correspondence Address: MAYER, FORTKORT & WILLIAMS, PC, 251 NORTH AVENUE WEST, 2ND FLOOR, WESTFIELD, NJ, 07090, US

(73) Assignees: Sony Corporation; Sony Electronics Inc.

(21) Appl. No.: 10/401,527

(22) Filed: Mar. 28, 2003

(51) Int. Cl. H01J 9/00; H01J 9/236

(52) U.S. Cl. 445/45

(57) ABSTRACT

A spacing device that, when integrated with a deflection yoke, enables proper alignment of the deflection yoke vis-à-vis the display screen without tilting. Several individual spacers are placed between the windings in cavities that accommodate the spacers, and the spacers are composed of an elastic plastic or rubber material that compresses under pressure and expands when the pressure is removed. The spacers allow the deflection yoke to be clamped in place and prevent tilting of the deflection yoke during the clamping process. Once clamped in place, the deflection yoke can be adjusted in the z direction to permit adjustment of the deflection yoke on the cathode ray tube vis-à-vis the glass to provide optimum picture quality (e.g., geometry, color purity, convergence, and focus).

### FIELD OF THE INVENTION

The present invention relates generally to deflection yokes and cathode ray tubes, and more particularly to a method for alignment/securing of a deflection yoke onto a cathode ray tube.

### BACKGROUND

Currently, for all applications utilizing a deflection yoke (DY) and cathode ray tube technology (e.g., televisions and computer monitor display systems), the deflection yoke must be aligned and secured on the funnel glass of the cathode ray tube (CRT). Traditionally, this is accomplished by one of three techniques.

According to a first technique, the deflection yoke is manually installed using wedges. While aligning the deflection yoke, three or more wedges (i.e., sloped pieces of rubber or plastic, with an adhesive on a tail piece) are manually inserted between the front cover of the deflection yoke and the glass funnel of the cathode ray tube. To prevent backward movement in the z-axis (the z-axis being parallel to the direction of insertion, whereas the xy-plane lies perpendicular to the direction of insertion), the deflection yoke is clamped to the cathode ray tube funnel neck via a clamp on the deflection yoke neck area.

Ideally, to provide optimum picture quality, a deflection yoke must be secured squarely on the cathode ray tube funnel (i.e., there must be equal spacing between the deflection yoke and the funnel in all axes). Because manual insertion of three or more wedges cannot be performed simultaneously, unequal force is applied to each wedge, resulting in a tilting of the deflection yoke (6 degrees of freedom). This creates unwanted process variation, degrading overall picture quality.

Additionally, each wedge requires adhesive to keep this wedge in place, and in some instances this adhesive does not effectively adhere to the cathode ray tube funnel, the wedge, and/or both. In this case, it is possible for the deflection yoke to move, once again affecting overall picture quality. To prevent this, many times the cathode ray tube funnel must be cleaned with alcohol and/or have Room Temperature Vulcanizing (RTV) adhesive applied at the wedge-to-funnel interface. This requires additional costs for materials and/or manpower.

According to a second technique, the deflection yoke is glued in place. To enable this, the deflection yoke has built-in channels, which provide pathways for hot glue to flow from a dispenser into the air void between the deflection yoke and the cathode ray tube funnel glass. As in the first technique, to prevent backward movement in the z-axis, the deflection yoke is clamped to the cathode ray tube funnel neck via a clamp on the deflection yoke neck area. While this method effectively secures the deflection yoke in place, any movement in the deflection yoke prior to the glue drying will fix the deflection yoke in a non-optimum position. Also, if there is a defect detected with the deflection yoke, cathode ray tube, chassis (or any combination of the three), and a rework (change of the part and a re-adjustment) is required, the deflection yoke and possibly the cathode ray tube may not be re-used due to the excessive glue inside/between the deflection yoke winding and cathode ray tube funnel. Examples of this would be process adjustments required after the deflection yoke was glued and any field service of these units that may be required. Additionally, the equipment requires much maintenance and provides some safety hazards.

According to a third technique, rods are used to secure the deflection yoke. Screw or push-type rods are added to (3 or more) areas of the deflection yoke itself. While aligning the deflection yoke, the rods are screwed or pushed forward until contact is made to the cathode ray tube funnel glass. As in the two techniques above, to prevent backward movement in the z-axis, the deflection yoke is clamped to the cathode ray tube funnel neck via a clamp on the deflection yoke neck area. This method also effectively secures the deflection yoke in place, however, tilting errors can occur depending upon variations in forces applied to the rods. If manually performed, many of the drawbacks seen in the first technique are encountered. If automatically performed, numerous adjustments and maintenance items are required. This method requires significant tooling startup costs, product design changes, and adds significant cost to each deflection yoke.

The present invention is therefore directed to the problem of developing a method and apparatus for aligning a deflection yoke with a cathode ray tube when assembling the two components.

### SUMMARY OF THE INVENTION

The present invention solves these and other problems by providing a spacing device that, when integrated with the deflection yoke, alleviates the problems described above.

According to one exemplary embodiment of the spacing device, several individual spacers (e.g., three or four or more) are placed between the windings in cavities that accommodate the spacers, and the spacers are composed of an elastic plastic or rubber material that compresses under pressure and expands when the pressure is removed. The spacers have one end that clips in the cavity or slot and another end that slips into the slot such that the spring force of expansion holds the spacer in the slot during alignment of the deflection yoke with the cathode ray tube. The spacers allow the deflection yoke to be clamped in place and prevent tilting of the deflection yoke during the clamping process. Once the spacers are in place, the deflection yoke can be adjusted in the z direction to permit adjustment of the cathode tube ray vis-à-vis the glass to provide optimum adjustment for visual performance.

### BRIEF DESCRIPTION OF THE DRAWINGS

FIG. 1 depicts a top view of an exemplary embodiment of a deflection yoke showing the cavities before any spacers are inserted according to one aspect of the present invention.

FIG. 2 depicts a top view of an exemplary embodiment of a deflection yoke having several spacers inserted in the cavities according to another aspect of the present invention.

FIG. 3 shows a side perspective view of the deflection yoke of FIG. 2.

FIG. 4 depicts a close-up view of an exemplary embodiment of one of the spacers of FIG. 2 according to another aspect of the present invention.

FIGS. 5-8 depict various views of an exemplary embodiment of a spacer according to another aspect of the present invention.

FIG. 9 depicts an exemplary embodiment of a method for aligning a deflection yoke when securing the deflection yoke to a cathode ray tube according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The apparatus described herein is designed to alleviate common problems currently associated with securing deflection yokes to cathode ray tube funnels in the television manufacturing and adjustment process. According to one aspect of the present invention, several (e.g., three or four) spacers are installed on the deflection yoke. When the deflection yoke is installed onto the cathode ray tube funnel, the deflection yoke can be pressed directly against the cathode ray tube funnel. This ensures proper X/Y/Z axis positioning because of the funnel's conical shape. Additionally, as is required, when z-axis adjustment is performed (for proper beam-to-phosphor adjustment), the spacers of the present invention allow for variation in cathode ray tube/deflection yoke part/process tolerances by maintaining a firm contact, at all times, between the deflection yoke and the cathode ray tube funnel. This tolerance is achieved by hole size, wall thickness, and the material of the spacer. Depending on the design requirements, this tolerance may be increased or decreased by changing these two parameters. This device is an attractive alternative to other current methods, such as manual wedge, gluing and/or using rods to secure the deflection yoke by virtues of low-cost, quality of securing and maintaining position, ease of implementation, re-work capability and lack of requirements for additional equipment.

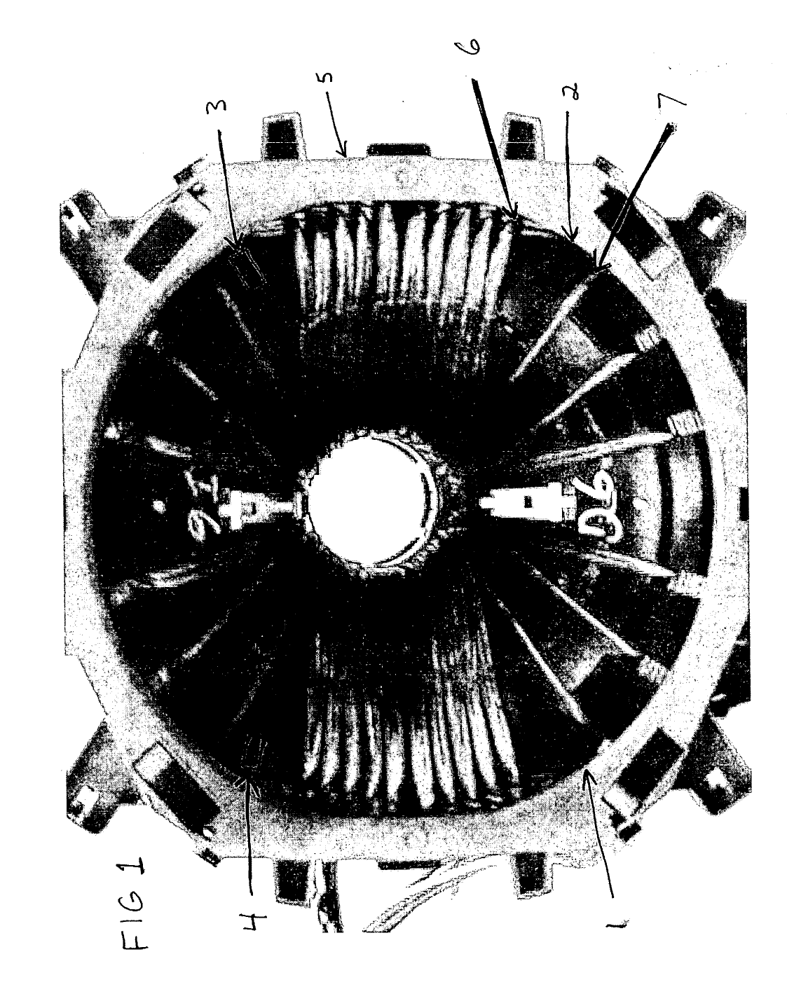

Turning to FIG. 1, shown therein is a deflection yoke 5 according to one aspect of the present invention. This deflection yoke 5 has several cavities 1-4 located between adjacent windings 6, 7 of the horizontal windings.

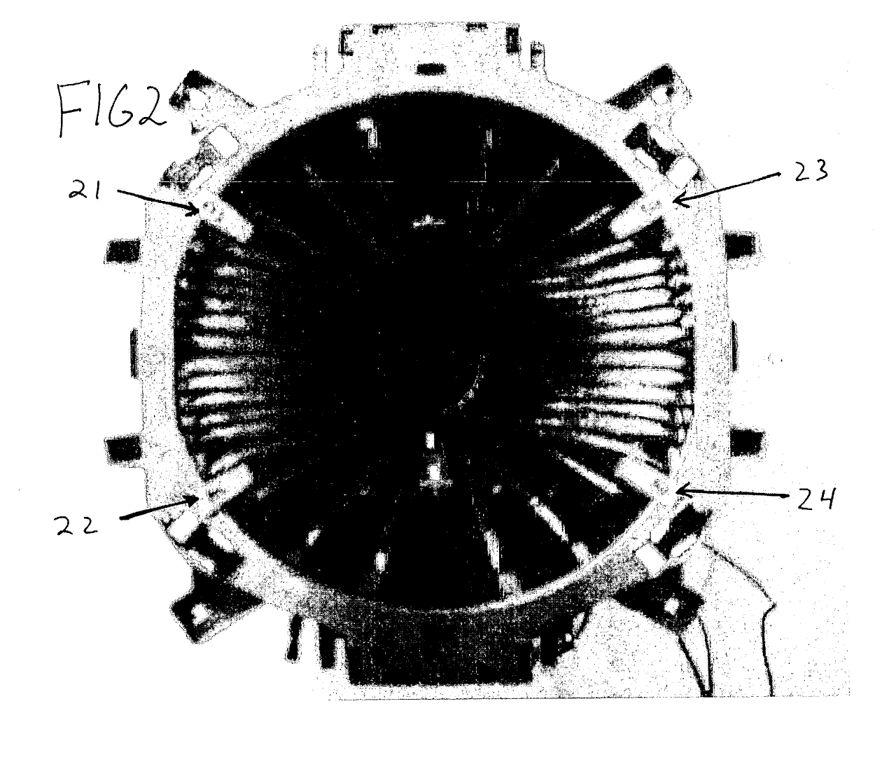

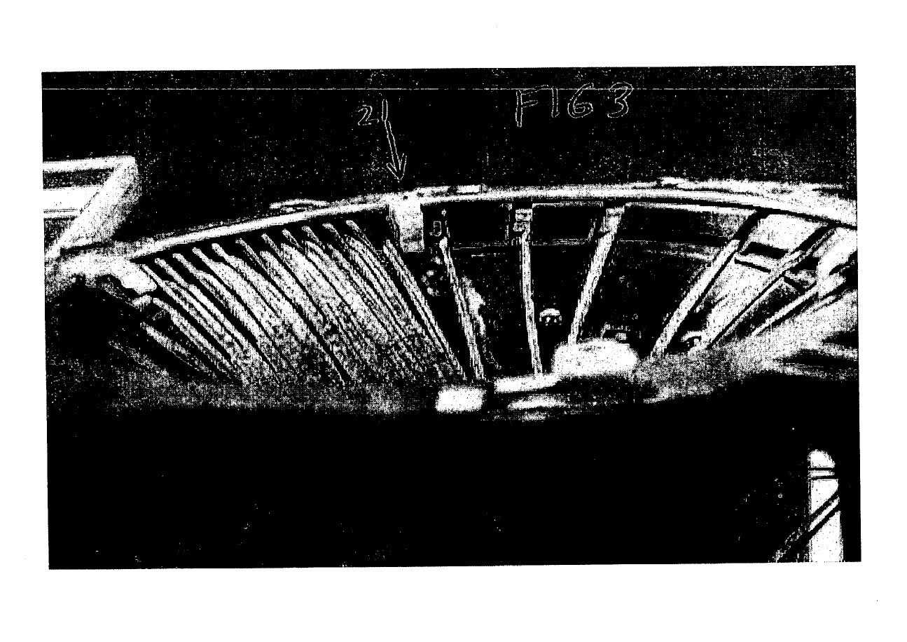

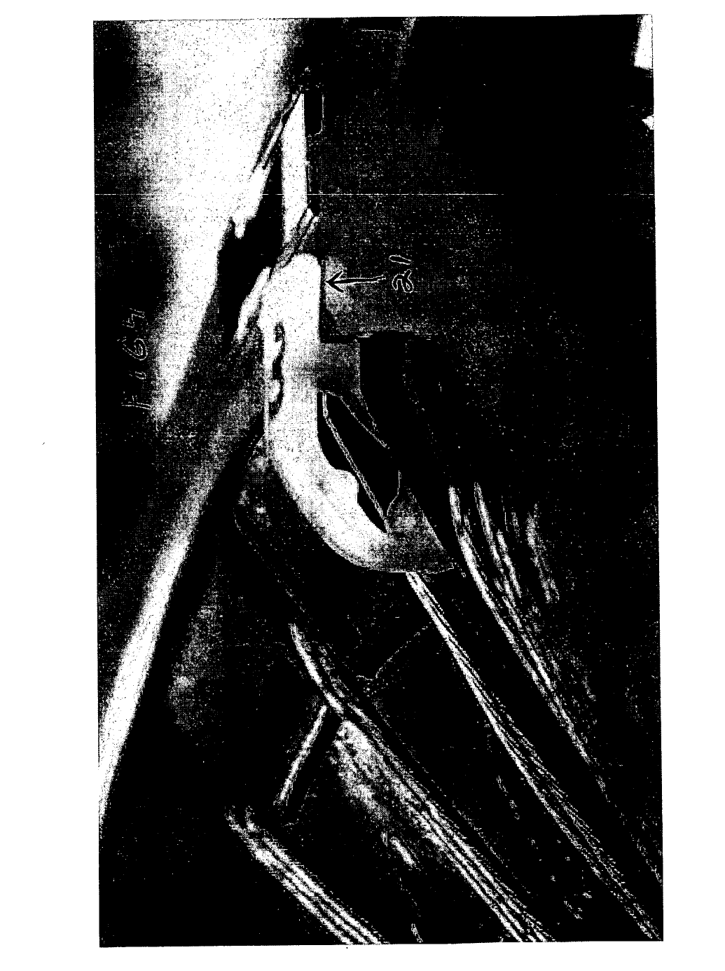

Turning to FIG. 2, shown therein is the deflection yoke 5 of FIG. 1 with spacers 21-24 inserted into the cavities or slots 1-4. FIG. 3 shows a top perspective view of the deflection yoke of FIG. 2. FIG. 4 shows a close-up view of one of the spacers 21.

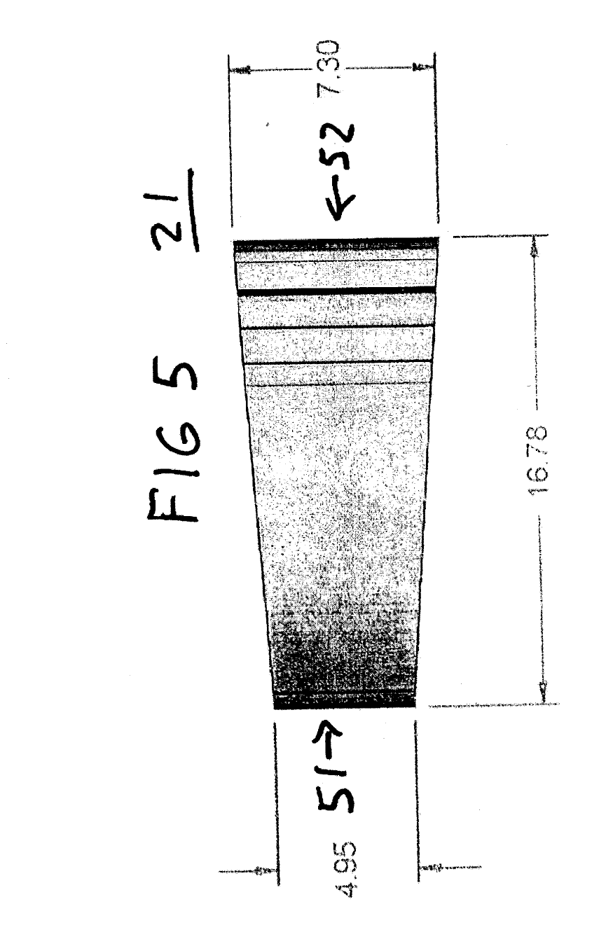

FIG. 5 shows a drawing of a top view of one of the spacers. The spacer is designed to fill the slot or cavity shape of the deflection yoke, The spacer 21 has a first end 51 that is the thinner of the two ends 51, 52 and a second end 52 that is the wider of the two ends 51, 52. The values for the various dimensions are in millimeters and are merely exemplary.

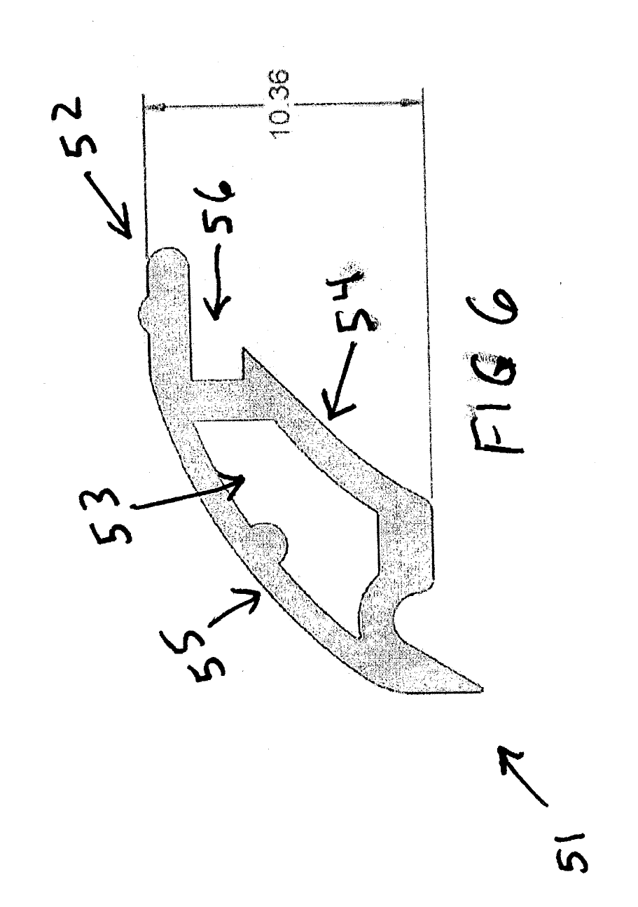

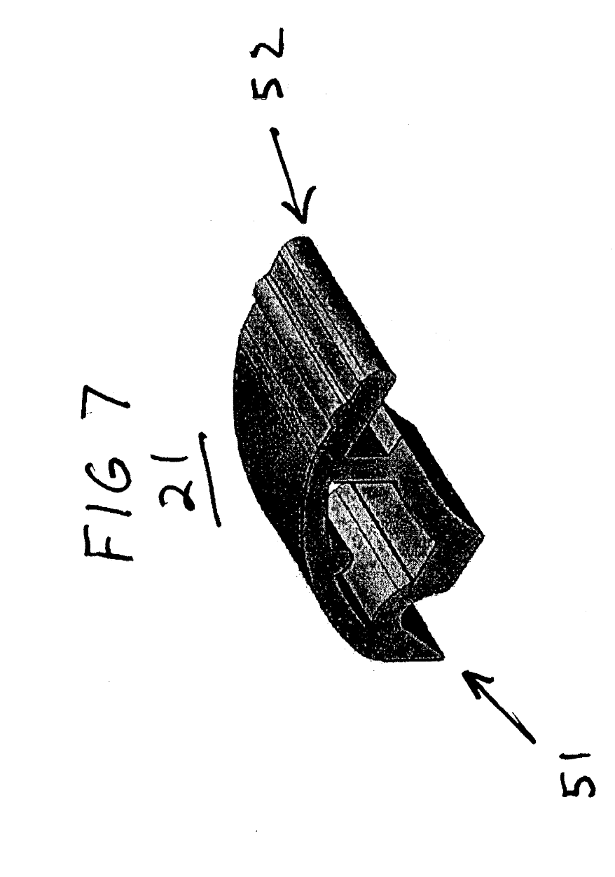

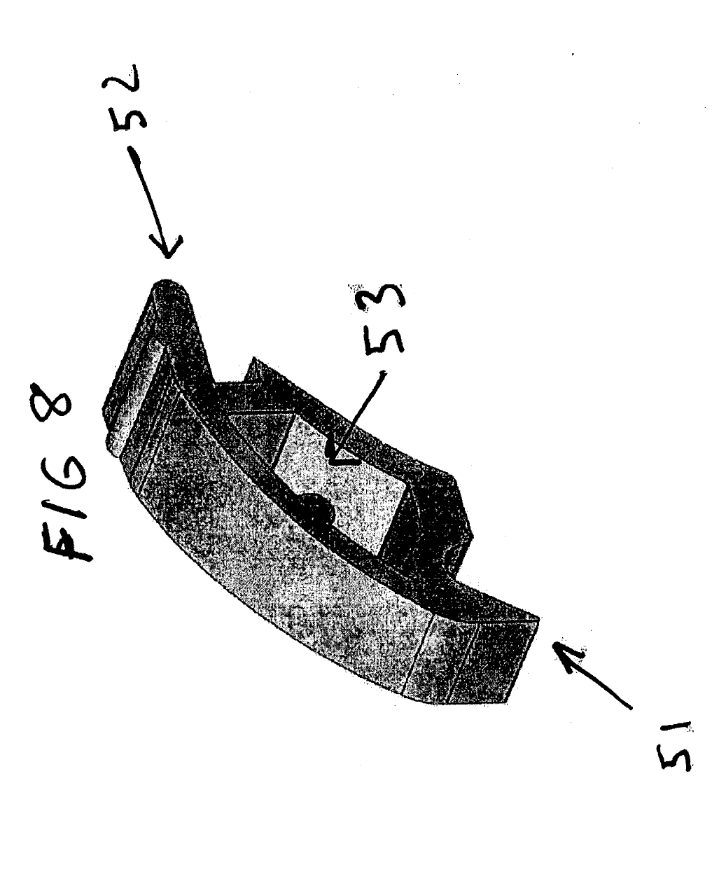

FIG. 6 shows a side view of the spacer 21 of FIG. 5. A center space 53 permits the spacer to compress and decompress. The spacer has a spring-like design that will make the spacer expand back to its original shape when a force compressing the spacer is removed or reduced. The wider end 52 has a clip 56 that clips the spacer to the slot. A sloped surface 54 of the spacer matches the sloping surface of the slot. The top surface 55 is contoured to continuously contact the CRT Funnel. FIGS. 7-8 show a side perspective view of the spacer of FIG. 5.

As shown in FIG. 1, four of the spacers of the present invention solve the problems with the techniques currently employed. Rather than fixing the deflection yoke in the z-axis by clamping the deflection yoke neck and then securing the deflection yoke in the x and y directions by manually wedging, the deflection yoke can be pushed forward until a proper position in the z-axis is achieved, and then simply clamped. The X/Y position is accurately accomplished automatically because it must conform to the cathode ray tube funnel shape, which is the ideal position. The hole in the device provides allowance in the z-direction, which is required by nature of variations in the cathode ray tube manufacturing process. Yet the deflection yoke remains secure within the range of tolerance that is provided. A “clean” cathode ray tube funnel is not required since there is no adhesive required. The deflection yoke will not change position due to poor adhesive or wedge movement by vibration or other means.

During adjustment of the deflection yoke in the z direction, the spacers must permit compression (1 to 4 mm, depending on CRT/Deflection Yoke design), and once compressed, should expand back when the force is removed to permit adjustment in the opposite direction. Thus, the deflection yoke is first pressed flush against the spacers, and then further compressed to a point where the deflection yoke and CRT are properly aligned. The spacers can then be compressed or decompressed as required. This essentially covers the range of movement required to adjust the beam-to-phosphor alignment to account for manufacturing tolerances and other deviations from the ideal.

Moreover, there is no requirement for extra equipment and no safety hazards. If rework is required because of a defect detected, the deflection yoke can easily be removed and all parts can be re-used.

Furthermore, as described above, the X/Y position is accurately accomplished. There is no additional equipment or maintenance required. Depending on the design, the spacers may need to be replaced when rework is required.

To secure the spacers of the present invention, a clip-on style is employed. This allows the spacers to be re-used with minimal effort.

An alternative to the clip-on approach uses an adhesive backing on the spacers, which are then applied to the deflection yoke. Due to television requirements, the spacers of the present invention are composed of V0—a non-flammable material. The material must be flexible enough to flex, but rigid enough to maintain constant force between the deflection yoke and the cathode ray tube funnel without exceeding material yield. A rubber or vinyl material works well for these reasons.

In addition, the spacers can be incorporated directly into the design of the deflection yoke, thereby removing the requirement that they be manually inserted during alignment. This also reduces cycle time and part count of the manufacturing process.

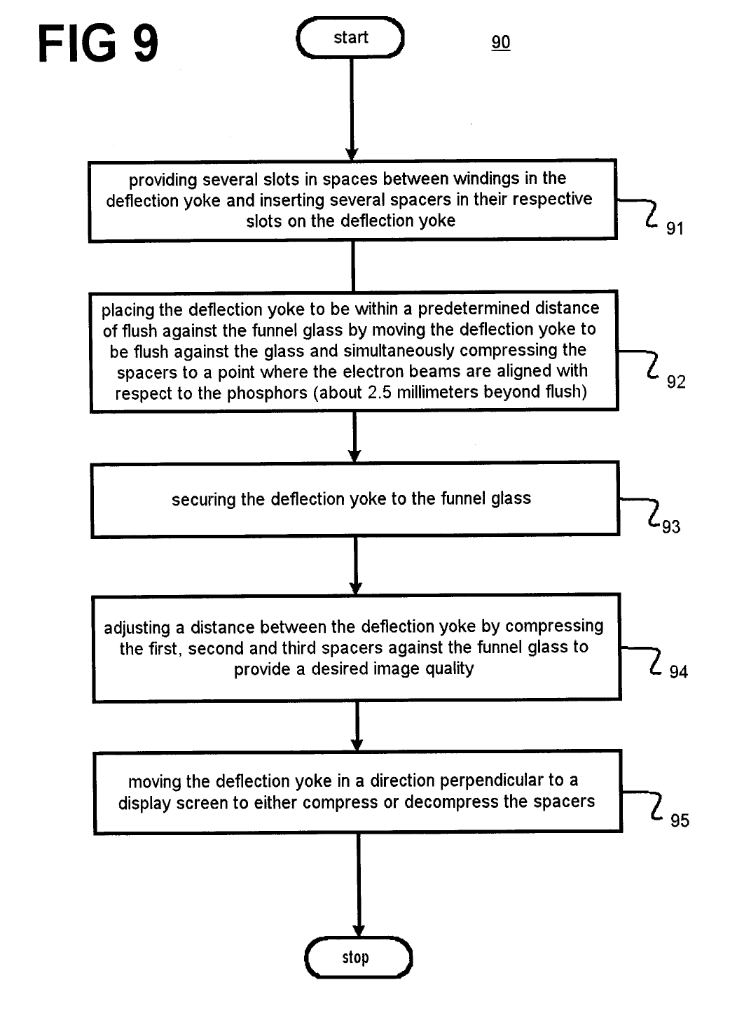

FIG. 9 shows an exemplary embodiment of a method for securing a deflection yoke to a cathode ray tube.

First, several slots are provided in spaces between windings in the deflection yoke and several spacers are inserted in their respective slots on the deflection yoke (element 91).

The deflection yoke is then placed to flush against the funnel glass and compressing the spacers to a point where the electron beams are aligned with respect to the phosphors (element 92). The deflection yoke is then secured to the funnel glass (element 93). A distance between the deflection yoke and the glass is adjusted by simultaneously compressing the spacers against the funnel glass to provide a desired image quality (element 94) by moving the deflection yoke in a direction perpendicular to a display screen to either compress or decompress the spacers (element 95).

Although various embodiments are specifically illustrated and described herein, it will be appreciated that modifications and variations of the invention are covered by the above teachings and are within the purview of the appended claims without departing from the spirit and intended scope of the invention. For example, a specific number of spacers is shown, however, other numbers and locations are possible without departing from the scope of the present invention. Furthermore, this example should not be interpreted to limit the modifications and variations of the inventions covered by the claims but is merely illustrative of one possible variation.

What is claimed is:

1. A method for aligning a deflection yoke during installation on a funnel glass of a cathode ray tube comprising:
inserting a first spacer in a first slot on the deflection yoke;
inserting a second spacer in a second slot on the deflection yoke;
inserting a third spacer in a third slot on the deflection yoke; and
placing the deflection yoke to be within a predetermined distance of flush against the funnel glass.

2. The method according to claim 1, further comprising:
inserting a fourth spacer in a fourth slot on the deflection yoke.

3. The method according to claim 1, further comprising:
securing the deflection yoke to the funnel glass.

4. The method according to claim 1, further comprising:
adjusting a distance between the deflection yoke by compressing the first, second and third spacers against the funnel glass to provide a desired image quality.

5. The method according to claim 4, wherein the adjusting further comprises:
moving the deflection yoke in a direction perpendicular to a display screen to either compress or decompress the spacers.

6. The method according to claim 2, wherein the placing further comprises:
moving the deflection yoke to be flush against the glass; and
compressing simultaneously with said moving the first, second, third, and fourth spacers to a point where a plurality of electron beams are aligned with respect to a plurality of phosphors.

7. The method, according to claim 6, wherein the point where the plurality of electron beams are aligned with respect to the plurality of phosphors comprises about 2.5 millimeters beyond flush.

8. The method according to claim 2, further comprising providing the first slot, the second slot, the third slot, and the fourth slot in a space between windings in the deflection yoke.

9. The method according to claim 2, wherein the first, second, third, and fourth spacers are made of a non-conductive and non-flammable material.

10. A method for aligning a deflection yoke during installation on a funnel glass of a cathode ray tube comprising:
inserting a first compressible spacer in a first slot disposed between two horizontal windings in a separator of the deflection yoke;
inserting a second compressible spacer in a second slot disposed between two horizontal windings in the separator of the deflection yoke;
inserting a third compressible spacer in a third slot disposed between two horizontal windings in the separator of the deflection yoke;
inserting a fourth compressible spacer in a fourth slot disposed between two horizontal windings in the separator of the deflection yoke; and
placing the deflection yoke to be within a point where a plurality of electron beams are aligned with respect to a plurality of phosphors to flush against the funnel glass.

11. The method, according to claim 10, further comprising:
securing the deflection yoke to the funnel glass; and
adjusting a distance between the deflection yoke by simultaneously compressing the first, second, third, and fourth spacers against the funnel glass to the point where the plurality of electron beams are aligned with respect to the plurality of phosphors to provide a desired image quality.

12. The method, according to claim 10, wherein the placing further comprises:
moving the deflection yoke to be flush against the glass; and
compressing the first, second, third, and fourth spacers to the point where the plurality of electron beams are aligned with respect to the plurality of phosphors.

13. The method according to claim 12, wherein the point where the plurality of electron beams are aligned with respect to the plurality of phosphors comprises about 2.5 millimeters beyond flush.

14. The method, according to claim 11, wherein the adjusting further comprises:
moving the deflection yoke in a direction perpendicular to a display screen to either compress or decompress the spacers.

15. The method, according to claim 10, further comprising providing the first slot, the second slot, the third slot and the fourth slot in a space between windings in the deflection yoke.

16. The method, according to claim 10, wherein the first, second, third and fourth spacers are made of a non-conductive and non-flammable material.

17. A spacer for use in aligning a deflection yoke on the funnel glass of a cathode ray tube comprising:
a first end having two protrusions forming a clip to accept a rim of the slot;
a second end having a sloped point to insert into the slot, thereby holding the spacer in place by compression; and
a middle section between the first end and second end having a shape forming an enclosed space (or cantilever), one side surface of which middle section being sloped to match a surface of the slot, wherein said spacer is formed of an elastic material and has a thickness to fit the slot in the deflection yoke.

18. The spacer, according to claim 16, wherein the material comprises a non-conductive material.

19. The spacer, according to claim 16, wherein the material comprises a material non-flammable material.

20. The spacer, according to claim 16, wherein the material comprises a material having an Underwriters Laboratory rating of V0.
